(19) United States
(12) Patent Application Publication
(10) Pub. No.: US 2011/0054994 A1
(43) Pub. Date: Mar. 3, 2011

(54) INFRASTRUCTURE FOR MARKETING DISPARATE SERVICES

(76) Inventor: Anne Kelly, San Clemente, CA (US)

(21) Appl. No.: 12/855,616

(22) Filed: Aug. 12, 2010

Related U.S. Application Data
(60) Provisional application No. 61/238,488, filed on Aug. 31, 2009.

(51) Int. Cl. G06Q 30/00

(52) U.S. Cl. 705/14.35; 705/14.1

(57) ABSTRACT

Methods for implementing a discount program directed to reducing costs to a consumer for first and second disparate services provided by first and second unrelated entities are described. A seller can sell addition of the consumer to the discount program, without requiring the consumer to purchase anything else from the seller to benefit from the program.

This application claims the benefit of priority to U.S. provisional application having Ser. No. 61/238488 filed on Aug. 31, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is marketing infrastructure.

### BACKGROUND

A great many different programs have been used over the years to incentivize consumers to purchase products and services. No matter how the program is implemented, however, the program must have some way of covering its costs.

In what is referred to herein as “free” discount programs, a discount card, book or other indicia is provided to consumers without any direct payment on the part of consumers for the indicia. In many such cases the programs generate revenue by tying in the discounts to purchase of some other goods or services. Examples include issuance of American Automobile Assn. (AAA®) cards, Benesaver® cards for discount plastic surgery, and pharmacy discount cards to consumers that purchase medical insurance. In other cases free discount programs generate revenue by tying the discounts to rebates or other payments from service providers utilized by the consumers. Thus, for example, programs that mail out free discount coupons often generate revenue by charging service providers for advertising in the coupons.

In what is referred to herein as “paid” discount programs, a discount card, book or other indicia is provided to consumers only upon direct payment on the part of consumers for the indicia. As with the free discount programs, paid discount programs may or may not be tied to the purchase of something else from the program's seller. For example, discount stores such as Costco® charge for memberships, and additional revenue is realized from purchases at the stores. The Entertainment Book™ and the Student Advantage™ card charge for the discount books and cards, respectively, but neither typically receive any further revenue when those cards are used to make purchases.

In that latter case, where paid programs receive no further revenue when the discounts are taken, there is little incentive (and possibly little funds) for the program to keep track of consumer transactions that utilize the discount. Indeed, to the best knowledge of the current applicant, the only known paid discount programs that track transactions related to consumers' use of the discounts all require some sort of extra purchase on the part of the consumers.

Thus, there is still a need for a paid discount program that doesn't require additional purchases on the part of consumers, but that does track consumer transactions that utilize the discount.

### SUMMARY OF THE INVENTION

The inventive subject matter provides apparatus, systems and methods in which a discount program is provided that does not require a consumer to purchase anything else from a seller to benefit from the program. The discount program advantageously allows consumers to receive discounts on first and second disparate services provided by respective first and second unrelated entities.

As used herein, “disparate services” means services in different fields that are not normally provided by the same service provider (e.g., dental services and massage therapy). As used herein, “unrelated entities” means entities having no parent-child or sibling relationship, and that no more than a 5% common ownership. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary

In preferred embodiments, at least one of the disparate services is an elective medical service, which is used herein to mean a service that is not medically essential, but legally requires the provider (in the jurisdiction in which the service is being provided) to have one or more of the following degrees: M.D. (Doctor of Medicine), D.O. (Doctor of Optometry), D.D.S. (Doctor of Dental Surgery), D.M.D. (Doctor of Dental Medicine), D.P.M. (Doctor of Podiatric Medicine), D.C. (Doctor of Chiropractic), N.D. (Naturopathic Doctor), and an M.S. or Ph.D. in Psychology. In California, for example, elective medical services include Botox® and other cosmetic injections, elective plastic surgery, LASIK surgery, some teeth whitening procedures, and braces for teeth.

In other contemplated embodiments, at least one of the disparate services is a beauty-spa service. As used herein, “beauty-spa” services means beauty services (e.g., hair, nails, and skin services), spa services (e.g., massages, facials, etc.), non-prescription exercise-related services (e.g., personal trainers and gym memberships), and nutrition-related services (e.g., non-prescription dietary supplements).

It is contemplated that discount programs could be sold through any suitable channels, including especially insurance agents that handle health policies. Of particular interest are the thousands of commissioned independent insurance agents, which can collectively provide a vast, pre-existing sales and marketing infrastructure.

One aspect of the inventive subject matter includes providing systems and methods in which: (1) a seller sells addition of a consumer to a discount program discount program; (2) without requiring the consumer to purchase anything else from the seller to benefit from the program; (3) the program allows consumers to receive discounts on first and second disparate services provided by respective first and second unrelated entities; and (4) there is a computer infrastructure that tracks transactions related to the consumer's use of the discount program.

Although a discount program could add a consumer without delivering a discount card, book or other indicia to that consumer, consumers would likely receive some sort of card indicia. As used herein, “card indicia” means a tangible item that contains at least one piece of identifying information (e.g., consumer number, name, etc.) related to the card's owner, or identifies a group to which the card's owner belongs. Preferred cards have a magnetic stripe and/or embossed lettering. Additionally or alternatively, consumers could receive discount books of coupons, which the consumers could either use themselves, or pass along to friends or acquaintances, and thereby enticing others to join the program.

All suitable manner of computer infrastructures can be used to track transactions related to consumers' use of a discount program. Contemplated computer infrastructure includes one or more consumer relationship management (“CRM”) systems, which preferably have at least one server capable of storing and processing data related to discount card transactions, and one or more user interfaces (e.g., consumer interface, seller (vendor) interface, service provider interface, advertiser interface, management interface, etc.). Consumer interfaces could be used, for example, to allow consumers to activate the program, manage their accounts, and find service providers. It is also contemplated that the CRM system could be coupled to a social network to allow consumers to coordinate visits to service providers, and suggest product to their friends. Among other things, the computer infrastructure would likely maintain name and contact information for consumers, purchase history, as well as keeping track of one-year or other expiration periods.

The CRM system can optionally be configured to track traffic to vendors, and could also be configured to track member satisfaction. In some contemplated embodiments, the CRM system could be provided free to vendors.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a diagram illustrating an embodiment of a method of implementing a discount program.

### DETAILED DESCRIPTION

Throughout the following discussion, numerous references will be made regarding servers, services, interfaces, engines, platforms, or other systems formed from computing devices. It should be appreciated that the use of such terms is deemed to represent one or more computing devices having at least one processor configured to execute software instructions stored on a computer readable media. For example, a server can include a computer operating as a web server, database server, or other type of computer server in a manner to fulfill described roles, responsibilities, or functions. One should appreciate that the deployment of the disclosed subject matter provides a platform that reduces an amount of processing time for managing aliases or distribution lists. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

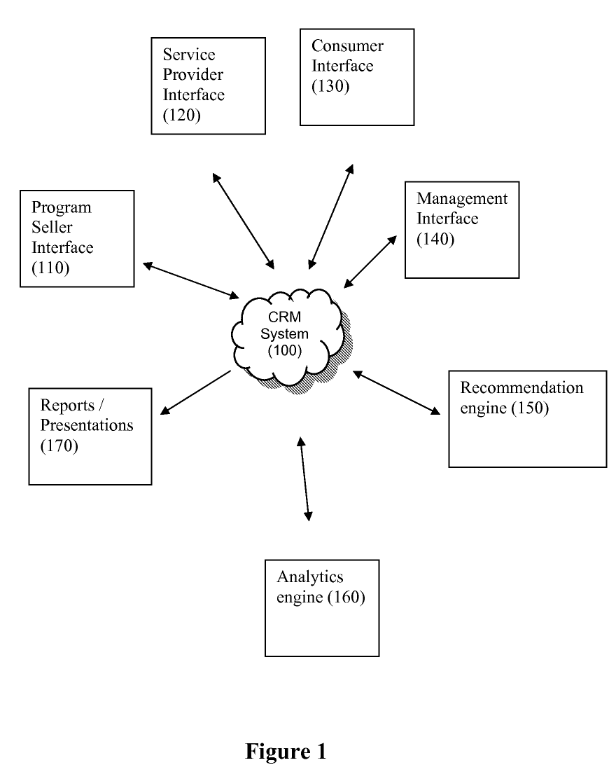

As shown in FIG. 1, insurance agents or other sellers of the program could be provided with an electronic interface 110 that allows them to perform various functions related to the discount program including, for example, signing up and activating new consumers, following up with previous purchasers of the discount program, and monitoring their sales of the discount program over time. In some contemplated embodiments, sellers could activate the discount program through one or more insurance networks. Through the seller interface or separately, sellers could be supplied with various reports, including monthly revenue generated by their sales of the discount program, the number of consumers that purchased services during a specified time period, etc.

The service provider interface 120 could be accessed via a web browser, or by software installed on service providers' computers. Advantageously, use of such interface 120 could be leased to service providers. Contemplated uses of the interface 120 by the service providers could include verifying consumer's status in the program, recording consumers' visits and the services and products provided to those consumers, scheduling appointments, tracking program consumer visits and spending habits, and referring consumers to other service providers. For example, a cosmetologist that sees a mole while cutting a consumer's hair could refer that consumer to a dermatologist. For such referrals, service providers could receive commissions, fees, or other benefits. Through the service provider interface 120, or separately, service providers could be supplied with the number of consumers residing within a specified distance from the service providers, revenue generated by the consumers and other analysis of the visits of consumers.

As an added benefit, the CRM system could optionally include a database populated with contact and other information of service providers not yet affiliated with the program. A contract or other registration form could then be pre-populated with information from the database to simplify the process of registering new service providers.

In addition to the interfaces discussed above, preferred systems also include a management interface 140 that allows internal management of various aspects of the discount program. For example, the management interface 140 could allow for program activation, monitoring of sales of the program by sellers, and monitoring of consumers' spending and usage of the program by service provider, region, demographic, etc.

In a preferred aspect of the present invention, the CRM system 100 includes an analytics engine 160 configured to analyze all aspects of the transactions involving the discount program. Contemplated analysis could be conducted, for example, within a single field of service providers and/or among disparate service providers. Thus, for example, the analytics engine 160 could be used to provide meaningful data regarding the behavior and trends of consumers across disparate services. This would advantageously allow for marketing of services to consumers and other consumers across such disparate services, which has traditionally been impracticable. Such cross marketing would allow service providers to substantially increase their consumer base.

It is contemplated that the resulting reports, presentations, or other results of the analytics engine 160 could be viewed through one of the interfaces discussed above and/or an analysis interface.

Preferred CRM systems advantageously have the ability to track the spending of each program consumer (e.g., service providers visited, amounts spent at each service provider, and which services/products were provided). Such information allows for directed marketing to consumers, both individually and by one or more demographics. In addition, such information could be used to obtain new sellers and service providers, to negotiate discounts provided by various service providers, and to determine the cost of the discount program.

A recommendation engine 150 could also be provided that uses the consumers' purchase histories across the disparate services to make useful recommendations of products and services to consumers. Thus, for example, instead of merely recommending a different spa treatment for consumers who purchased a spa treatment, the recommendation engine 150 could recommend an elective medical service that is commonly undertaken by consumers who purchased that spa treatment. Such recommendations are preferably presented to consumers via the card owner's interface, though other mediums are contemplated (e.g., email, flyers, etc.).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of implementing a discount program directed to reducing costs to a consumer for first and second disparate services provided by first and second unrelated entities, respectively, comprising:
a seller selling addition of the consumer to the discount program, without requiring the consumer to purchase anything else from the seller to benefit from the program; and
providing a computer infrastructure that tracks transactions related to the consumer's use of the program.

2. The method of claim 1, further comprising selling the program to the consumer via independent insurance agents.

3. The method of claim 2, wherein at least one of the disparate services is an elective medical service.

4. The method of claim 3, wherein at least one of the disparate services is a beauty-spa service.

5. The method of claim 1, further comprising providing the consumer a card indicia having an identifying information.

6. The method of claim 1, further comprising providing the consumer at least one coupon having identifying information.

7. The method of claim 1, further comprising causing the program to expire after a predetermined time period.

8. The method of claim 1, further comprising providing an interface via the computer infrastructure through which the consumer can activate the program.

9. The method of claim 1, further comprising providing an analysis engine configured to analyze usage of the program and generate a report.

10. The method of claim 9, further comprising providing the analysis engine configured to analyze the consumer's use of the program across a plurality of first and second disparate services, and generate a report.

11. The method of claim 9, further comprising providing a recommendation engine configured to recommend a service to the consumer based upon the report.
